(19) United States
(12) Patent Application Publication
(10) Pub. No.: US 2025/0010747 A1
(43) Pub. Date: Jan. 9, 2025

(54) CONTROL SYSTEM AND CONTROL DEVICE

(71) Applicant: SUBARU CORPORATION, Tokyo (JP)

(72) Inventor: Shinya HORIE, Tokyo (JP)

(21) Appl. No.: 18/894,073

(22) Filed: Sep. 24, 2024

Related U.S. Application Data
(63) Continuation of application No. PCT/JP2023/025039, filed on Jul. 5, 2023.

(51) Int. Cl. B60L 53/36; B60W 60/00

(52) U.S. Cl. CPC B60L 53/36; B60W 60/001

(57) ABSTRACT

A control system includes one or more processors and one or more memories coupled to the one or more processors. The one or more processors are configured to execute processing. The processing includes acquiring dimension information indicating a dimension of a vehicle entering a charging station. The processing includes generating travel path information indicating a travel path of the vehicle in the charging station, based on the dimension information and coordinate data of locations located in the charging station. The coordinate data of the locations located in the charging station is different from map data that is coordinate data of locations located outside the charging station. The processing includes executing, based on the travel path information, first automatic travel control to control the vehicle to automatically travel to a charger in the charging station without intervention of a driver who drives the vehicle in the charging station.

### CROSS-REFERENCE TO RELATED APPLICATIONS

This application is continuation of International Application No. PCT/JP2023/025039, filed on Jul. 5, 2023, the entire contents of which are hereby incorporated by reference.

### BACKGROUND

The disclosure relates to a control system and a control device.

In the related art, there are known electric vehicles that can be driven by motors using electric power stored in batteries. Charging stations having chargers capable of supplying electric power to batteries of electric vehicles are installed in various locations to charge the batteries. Such a charging station is disclosed in Japanese Unexamined Patent Application Publication No. 2011-114969. The charging station is provided with a control device that communicates with a control device disposed in a vehicle to exchange information, and the exchanged information is used to predict the time of completion of charging of the vehicle.

### SUMMARY

An aspect of the disclosure provides a control system including one or more processors and one or more memories coupled to the one or more processors. The one or more processors are configured to execute processing. The processing includes acquiring dimension information indicating a dimension of a vehicle entering a charging station. The processing includes generating travel path information indicating a travel path of the vehicle in the charging station, based on the dimension information and coordinate data of locations located in the charging station. The coordinate data of the locations located in the charging station is different from map data that is coordinate data of locations located outside the charging station. The processing includes executing, based on the travel path information, first automatic travel control to control the vehicle to automatically travel to a charger in the charging station without intervention of a driver who drives the vehicle in the charging station.

An aspect of the disclosure provides a control device including one or more processors and one or more memories coupled to the one or more processors. The one or more processors are configured to execute processing. The processing includes executing first automatic travel control to control a vehicle entering a charging station to automatically travel to a charger in the charging station without intervention of a driver who drives the vehicle in the charging station. The first automatic travel control is executed based on travel path information indicating a travel path of the vehicle in the charging station. The travel path information is generated based on dimension information indicating a dimension of the vehicle and coordinate data of locations located in the charging station. The coordinate data of the locations located in the charging station is different from map data that is coordinate data of locations located outside the charging station.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic configuration diagram of a control system according to an embodiment of the disclosure;

FIG. 2 is a schematic configuration block diagram of a first control device and a second control device according to the embodiment of the disclosure;

FIG. 3 is a block diagram illustrating an example functional configuration of the first control device according to the embodiment of the disclosure;

FIG. 4 is a block diagram illustrating an example functional configuration of the second control device according to the embodiment of the disclosure; and

FIG. 5 is a flowchart of a control process performed in the control system according to the embodiment of the disclosure.

### DETAILED DESCRIPTION

When driven on public roads outside a charging station by automatic travel control, a vehicle has no detailed coordinate data of locations located in the charging station. Thus, it is difficult to continue the automatic travel control after the vehicle enters the charging station. In the charging station, therefore, the vehicle is manually driven by a human driver.

It is desirable to provide a control system and a control device capable of automatic travel control in a charging station.

An embodiment of the disclosure will be described hereinafter with reference to the accompanying drawings. Specific dimensions, materials, numerical values, and so on provided in the embodiment of the disclosure are merely examples for facilitating understanding of the disclosure, and do not limit the disclosure unless otherwise specified. In the specification and the drawings, elements having substantially the same functions and configurations are denoted by the same reference numerals to omit redundant description, and elements not directly related to the disclosure are not illustrated.

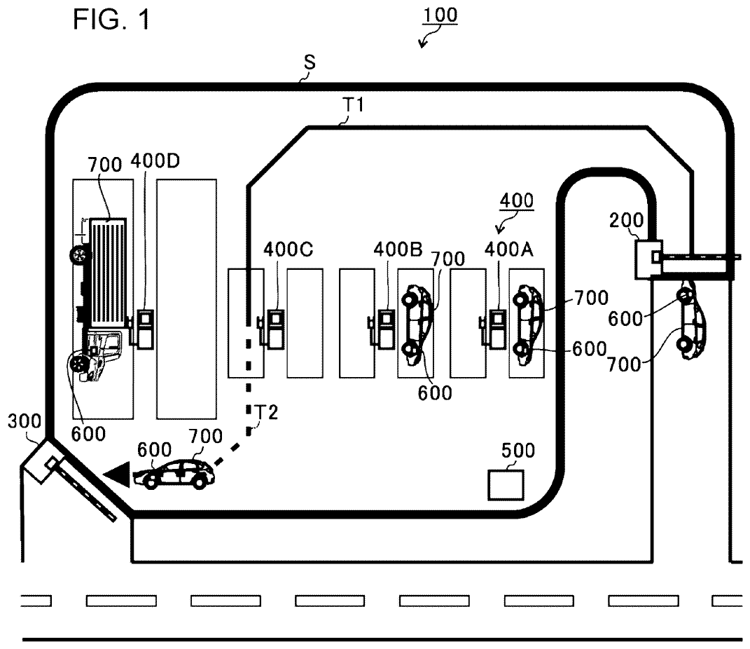

FIG. 1 is a schematic configuration diagram of a control system 100 according to the embodiment of the disclosure. As illustrated in FIG. 1, the control system 100 includes an entrance gate 200, an exit gate 300, chargers 400, a first control device 500, and a second control device 600.

The entrance gate 200, the exit gate 300, the chargers 400, and the first control device 500 are disposed in a charging station S. The second control device 600 is disposed in a vehicle 700 that can enter and leave the charging station S.

The entrance gate 200 is disposed at an entrance of the charging station S to open and close the entrance of the charging station S. The exit gate 300 is disposed at an exit of the charging station S to open and close the exit of the charging station S. When the entrance gate 200 is in open position, the vehicle 700 is allowed to pass through the entrance of the charging station S and is allowed to enter the charging station S from the outside. When the entrance gate 200 is in closed position, the vehicle 700 is not allowed to pass through the entrance of the charging station S and is not allowed to enter the charging station S from the outside.

When the exit gate 300 is in open position, the vehicle 700 is allowed to pass through the exit of the charging station S and is allowed to leave the charging station S from the inside. When the exit gate 300 is in closed position, the vehicle 700 is not allowed to pass through the exit of the charging station S and is not allowed to leave the charging station S from the inside.

Each of the chargers 400 includes a charging gun. The charging gun includes a cable and a connector. The cable couples a power supply (not illustrated) of the charger 400 to the connector. The cable has, for example, a retractable portion having a winding structure, and is configured to be retractable from the charger 400 to a charging port of the vehicle 700. The connector of the charger 400 can be electrically coupled to the charging port of the vehicle 700. The connector can supply alternating current or direct current from the power source (not illustrated) to the charging port of the vehicle 700.

Each of the chargers 400 can supply a larger amount of current when supplying direct current than when supplying alternating current. A charger 400 supplying alternating current can perform normal charging of a battery of the vehicle 700. A charger 400 supplying direct current can perform rapid charging of the battery of the vehicle 700.

The chargers 400 according to the embodiment of the disclosure include a first charger 400A, a second charger 400B, a third charger 400C, and a fourth charger 400D. The first charger 400A and the second charger 400B support first type information of batteries mounted on vehicles 700 and first version information. The version information indicates version information of software used in the vehicles 700 for charging. The version information of the software is hereinafter also simply referred to as version information.

The third charger 400C and the fourth charger 400D support second type information of batteries mounted on vehicles 700 and second version information. The first type information and the first version information are older than the second type information and the second version information, respectively.

Of the chargers 400 of multiple types, the first charger 400A and the second charger 400B support old battery type information, which is not the latest, and old software version information, which is not the latest. The third charger 400C and the fourth charger 400D support the latest battery type information and the latest software version information.

If the battery of the vehicle 700 is to be charged using a charger 400 not supporting the battery type information and software version information of the vehicle 700, the charging efficiency may be reduced or the charging of the battery may fail. It is therefore desirable to charge the battery of the vehicle 700 using a charger 400 supporting the battery type information and software version information of the vehicle 700.

In the description given herein, the vehicle 700 is an electric vehicle with a motor (not illustrated) and a battery (not illustrated) mounted thereon. It is noted that the vehicle 700 is any vehicle including at least a motor (not illustrated) to control the vehicle 700 to travel and a battery to drive the motor. For example, the vehicle 700 may be a hybrid vehicle including an engine and a motor.

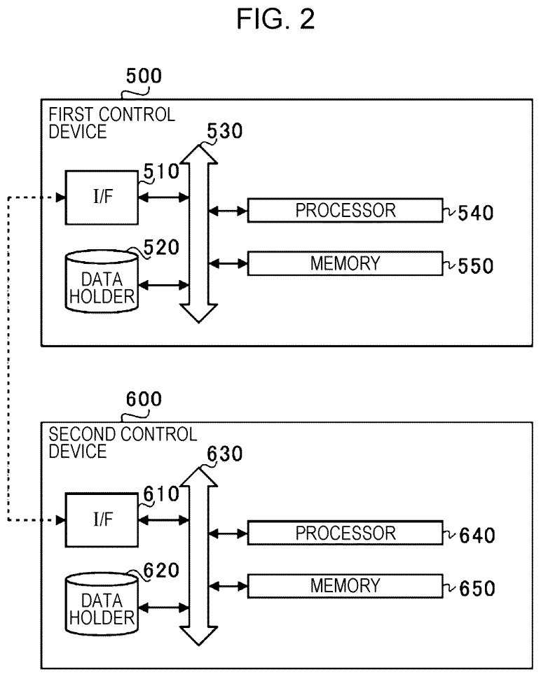

FIG. 2 is a schematic configuration block diagram of the first control device 500 and the second control device 600 according to the embodiment of the disclosure. As illustrated in FIG. 2, the first control device 500 includes an interface (I/F) 510, a data holder 520, a system bus 530, one or more processors 540, and one or more memories 550. The I/F 510 is an interface for communicating with the second control device 600.

The data holder 520 includes, for example, a random access memory (RAM), a flash memory, and a hard disk drive (HDD) and holds various kinds of information to be used for processing of the one or more processors 540 described below. For example, the data holder 520 holds vehicle-related information of the vehicle 700, which is acquired via the second control device 600. In one example, the data holder 520 holds, for example, information acquired from the vehicle 700, namely, identification information, dimension information, and vehicle information, which will be described below in detail, information related to the chargers 400, and information related to the charging station S. The information related to the chargers 400 includes, for example, battery type information supported by the chargers 400, software version information supported by the chargers 400, and information on the positions of the proximal ends of the cables of the chargers 400 and the maximum lengths of the cables of the chargers 400. The information related to the charging station S includes coordinate data of the charging station S. For example, the information related to the charging station S includes coordinate data indicating the widths of roads and the curvatures of curves in the charging station S, and coordinate data indicating the installation locations of the chargers 400. The system bus 530 is a transmission line that electrically couples the I/F 510, the data holder 520, the one or more processors 540, and the one or more memories 550 to one another to transmit data among them.

The one or more processors 540 include, for example, a central processing unit (CPU). The one or more memories 550 include, for example, a read only memory (ROM) and a RAM. The ROM is a storage element that stores programs, operation parameters, and the like used by the CPU. The RAM is a storage element that temporarily stores data of variables, parameters, and the like used for processing executed by the CPU.

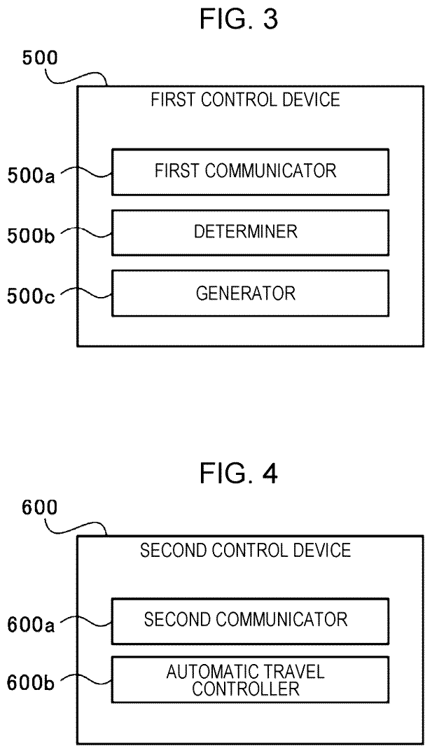

FIG. 3 is a block diagram illustrating an example functional configuration of the first control device 500 according to the embodiment of the disclosure. For example, as illustrated in FIG. 3, the first control device 500 includes a first communicator 500a, a determiner 500b, and a generator 500c.

In the first control device 500, various processes including processes performed by the first communicator 500a, the determiner 500b, and the generator 500c, which will be described below, may be executed by the one or more processors 540 in cooperation with a program included in the one or more memories 550. In one example, the one or more processors 540 execute a program stored in the one or more memories 550 to perform the various processes.

The first communicator 500a communicates with the second control device 600 mounted in the vehicle 700. The determiner 500b determines, based on the vehicle-related information of the vehicle 700, one of the chargers 400 that is compatible with the battery mounted on the vehicle 700. The generator 500c generates travel path information indicating a travel path in the charging station S. The first communicator 500a, the determiner 500b, and the generator 500c will be described in detail below.

Referring back to FIG. 2, the second control device 600 includes an I/F 610, a data holder 620, a system bus 630, one or more processors 640, and one or more memories 650. The I/F 610 is an interface for communicating with the first control device 500.

The data holder 620 includes, for example, a RAM, a flash memory, and an HDD and holds various kinds of information to be used for processing of the one or more processors 640 described below. For example, the data holder 620 holds the vehicle-related information of the vehicle 700. In one example, the data holder 620 holds identification information, dimension information, and vehicle information of the vehicle 700, which will be described in detail below, and information acquired from the first control device 500. The system bus 630 is a transmission line that electrically couples the I/F 610, the data holder 620, the one or more processors 640, and the one or more memories 650 to one another to transmit data among them.

The one or more processors 640 include, for example, a CPU. The one or more memories 650 include, for example, a ROM and a RAM. The ROM is a storage element that stores programs, operation parameters, and the like used by the CPU. The RAM is a storage element that temporarily stores data of variables, parameters, and the like used for processing executed by the CPU.

FIG. 4 is a block diagram illustrating an example functional configuration of the second control device 600 according to the embodiment of the disclosure. For example, as illustrated in FIG. 4, the second control device 600 includes a second communicator 600a and an automatic travel controller 600b.

Various processes including processes performed by the second communicator 600a and the automatic travel controller 600b, which will be described below, may be executed by the one or more processors 640 in cooperation with a program included in the one or more memories 650. In one example, the one or more processors 640 execute a program stored in the one or more memories 650 to perform the various processes.

The second communicator 600a communicates with the first communicator 500a of the first control device 500. The automatic travel controller 600b executes automatic travel control to control the vehicle 700 to automatically travel without the intervention of a human driver. In the embodiment of the disclosure, the automatic travel control includes first automatic travel control, second automatic travel control, and third automatic travel control. The first automatic travel control is control for controlling the vehicle 700 to automatically travel from the entrance gate 200 to any one of the chargers 400 in the charging station S. The second automatic travel control is control for controlling the vehicle 700 to automatically travel from the charger 400 to the exit gate 300 in the charging station S. The third automatic travel control is control for controlling the vehicle 700 to automatically travel outside the charging station S.

The operation of the control system 100 will be described in detail hereinafter with reference to FIG. 1. When the vehicle 700 arrives at the entrance gate 200 of the charging station S, communication is performed between the first control device 500 of the charging station S and the second control device 600 of the vehicle 700.

At this time, the first control device 500 acquires vehicle-related information of the vehicle 700 entering the charging station S from the second control device 600. The vehicle-related information includes, for example, identification information for identifying the vehicle 700, dimension information indicating dimensions of the vehicle 700, vehicle information, position information, information related to the battery mounted on the vehicle 700, and information related to software used in the vehicle 700 for charging. Examples of the identification information include vehicle identification number (VIN) information. The VIN information includes a serial number used to individually identify the vehicle 700. The identification information is not limited to the VIN information, and may include vehicle number information. The dimension information includes, for example, information such as a vehicle height, a total length, and a total width. The vehicle information includes, for example, information such as a reference position, a charging port position, a vehicle type, and a manufacturer of the vehicle 700. The reference position of the vehicle 700 is, for example, the position of the front edge of the vehicle 700 in the direction of travel of the vehicle 700. The charging port position of the vehicle 700 is, for example, a position represented by a relative position with respect to the reference position. The charging port position includes information on the right side or the left side of the vehicle 700 and relative position information such as xx meters away from the reference position in the direction of an angle α. The information on the charging port position is hereinafter also referred to as information related to the position of the charging port of the vehicle 700. The position information is, for example, information indicating the latitude and longitude of the location of the vehicle 700 detected by a global navigation satellite system (GNSS) sensor mounted on the vehicle 700.

Examples of the information related to the battery include type information of the battery and state of charge (SOC) information indicating the level of charge of the battery. Examples of the information related to the software used in the vehicle 700 for charging include version information of the software used to charge the battery.

The vehicle-related information is stored in advance in the data holder 620 of the second control device 600, and is transmitted from the second communicator 600a of the second control device 600 to the first communicator 500a of the first control device 500.

When the first communicator 500a acquires the vehicle-related information of the vehicle 700, the determiner 500b of the first control device 500 calculates, based on the acquired vehicle-related information, a relative positional relationship between the reference position of the vehicle 700 and a reference position in the charging station S. The reference position in the charging station S is, for example, a position serving as the origin of the coordinate system for the charging station S. Examples of the reference position in the charging station S include a position determined with reference to the entrance gate 200, and such a position is the position of the center of a bar of the entrance gate 200 in closed position. The reference position in the charging station S is stored in advance in the data holder 520 as position information expressed in latitude and longitude.

The determiner 500b calculates the reference position of the vehicle 700, which is expressed in latitude and longitude, based on, for example, the vehicle information and the position information. Further, the determiner 500b calculates the coordinates of the reference position of the vehicle 700 with respect to the reference position in the charging station S, which is expressed in latitude and longitude, and stores coordinate data of the calculated coordinates in the data holder 520. As a result, coordinate data indicating the positional relationship between the reference position of the vehicle 700 and the reference position in the charging station S is generated. The coordinate data indicating the positional relationship between the reference position of the vehicle 700 and the reference position in the charging station S is hereinafter also simply referred to as reference position coordinate data.

The first communicator 500a communicates with the second communicator 600a of the second control device 600, and requests permission from the driver of the vehicle 700 to execute the first automatic travel control and the second automatic travel control in the charging station S. If the driver gives no permission to execute the first automatic travel control and the second automatic travel control in the charging station S, the driver manually drives the vehicle 700 in the charging station S.

On the other hand, if the driver gives permission to execute the first automatic travel control and the second automatic travel control in the charging station S, the generator 500c generates travel path information indicating a travel path in the charging station S, based on the dimension information.

At this time, the determiner 500b determines a charger 400 to which the vehicle 700 is to be guided, based on the dimension information, the information related to the battery, and the information related to the software. In one example, the determiner 500b determines whether each of the chargers 400 illustrated in FIG. 1 is in use, and excludes the charger or chargers 400 currently in use from the four chargers 400 to determine an available charger 400. In the example illustrated in FIG. 1, the first charger 400A, the second charger 400B, and the fourth charger 400D are currently used by three vehicles 700. The determiner 500b excludes the first charger 400A, the second charger 400B, and the fourth charger 400D among the four chargers 400 and determines the third charger 400C as an available charger 400.

Further, the determiner 500b determines whether the dimensions of the vehicle 700 fit in each of the parking spaces provided on both sides of each of the chargers 400. The determiner 500b also determines whether the type information of the battery of the vehicle 700 and the version information of the vehicle 700 are supported by each of the chargers 400. In one example, the determiner 500b refers to the type information of the battery of the vehicle 700, the version information of the vehicle 700, and the information on the chargers 400 stored in the data holder 520 and determines the charger 400 supporting the type information of the battery of the vehicle 700 and the version information of the vehicle 700.

For example, when the type information is the second type information and the version information is the second version information, the determiner 500b determines that the type information of the battery of the vehicle 700 and the version information of the vehicle 700 are supported by the third charger 400C and the fourth charger 400D. The embodiment of the disclosure describes an example in which the charger 400 to which the vehicle 700 is to be guided is determined based on both the type information of the battery of the vehicle 700 and the version information of the vehicle 700. However, the disclosure is not limited thereto, and the determiner 500b may determine the charger 400 to which the vehicle 700 is to be guided, based on either of the type information of the battery of the vehicle 700 and the version information of the vehicle 700. For example, the determiner 500b may determine the charger 400 to which the vehicle 700 is to be guided, based on only the type information of the battery of the vehicle 700. Alternatively, the determiner 500b may determine the charger 400 to which the vehicle 700 is to be guided, based on only the version information of the vehicle 700.

Based on these determinations, the determiner 500b determines one charger 400 to which the vehicle 700 is to be guided. In one example, the determiner 500b selects a charger 400 that is available and supports the type information of the battery of the vehicle 700 and the version information of the vehicle 700 and for which the dimensions of the vehicle 700 fit in each of the parking spaces provided on both sides. In the example illustrated in FIG. 1, the determiner 500b determines whether the dimensions of the vehicle 700 fit in each of the parking spaces provided on both sides of the available third charger 400C. The determiner 500b also determines whether the available third charger 400C supports the type information of the battery mounted on the vehicle 700 and the version information of the vehicle 700. In the illustrated example, the determiner 500b determines that the dimensions of the vehicle 700 fit in each of the parking spaces provided on both sides of the third charger 400C. The determiner 500b also determines that the third charger 400C supports the type information of the battery mounted on the vehicle 700 and the version information of the vehicle 700. Based on such determination results, the determiner 500b determines the third charger 400C as the charger 400 to which the vehicle 700 is to be guided.

The generator 500c generates, based on the information determined by the determiner 500b, travel path information indicating travel paths T1 and T2 in the charging station S. In one example, the generator 500c generates the travel path information indicating the travel paths T1 and T2 in the charging station S, based on the charger 400 determined by the determiner 500b, the coordinate data of locations located in the charging station S, the reference position coordinate data, and the dimension information and the vehicle information of the vehicle 700.

The travel path T1 is a path along which the vehicle 700 is controlled to automatically travel from the entrance gate 200 to the determined charger 400 (in the illustrated example, the third charger 400C) without the intervention of the driver of the vehicle 700 in the charging station S. The generator 500c generates travel path information of the travel path T1, based on the coordinate data indicating the position of the charger 400 determined by the determiner 500b, the coordinate data indicating the position of the entrance gate 200, the reference position coordinate data, and the dimension information of the vehicle 700. The travel path T2 is a path along which the vehicle 700 is controlled to automatically travel from the determined charger 400 to the exit gate 300 without the intervention of the driver of the vehicle 700 in the charging station S. The generator 500c generates travel path information of the travel path T2, based on the coordinate data indicating the position of the charger 400 determined by the determiner 500b, the coordinate data indicating the position of the exit gate 300, the reference position coordinate data, and the dimension information of the vehicle 700.

At this time, the generator 500c generates the travel path information in consideration of the vehicle information of the vehicle 700. In one example, the generator 500c generates the travel path information, based on the information related to the charging port position of the vehicle 700, the position of the proximal end of the cable of the charging gun of the charger 400, and the maximum length of the cable of the charging gun, such that the charging port position of the vehicle 700 is located within the movable range of the charging gun. Further, the generator 500c generates the travel path information, based on the widths of the roads and the curvatures of the curves in the charging station S and the dimension information of the vehicle 700, to determine a route on which the vehicle 700 can travel in the charging station S. The dimension information of the vehicle 700 is used for, for example, calculation of a collision avoidance route for avoiding the collision of the vehicle 700 with an obstacle in the charging station S.

The first communicator 500a transmits the generated travel path information to the second communicator 600a of the second control device 600. The automatic travel controller 600b executes, based on the acquired travel path information, the first automatic travel control to control the vehicle 700 to automatically travel from the entrance gate 200 to the charger 400 without the intervention of the driver of the vehicle 700 in the charging station S. The first automatic travel control allows the vehicle 700 to automatically travel from the entrance gate 200 to the charger 400 along the travel path T1 illustrated in FIG. 1. In the example illustrated in FIG. 1, the first automatic travel control allows the vehicle 700 to automatically travel to a position at which the charging port position of the vehicle 700 is located within the movable range of the charging gun of the third charger 400C.

The first automatic travel control allows the vehicle 700 to automatically stop when the vehicle 700 moves to a parking space for the charger 400. Then, the battery of the vehicle 700 is charged in response to the charging gun of the charger 400 being coupled to the charging port of the vehicle 700. The coupling of the charging port of the vehicle 700 and the charging gun of the charger 400 may be automatically performed by an automatic coupling device (not illustrated) without the intervention of the driver of the vehicle 700 or may be manually performed by the driver of the vehicle 700.

When the charging of the battery of the vehicle 700 is completed, the automatic travel controller 600b executes, based on the travel path information, the second automatic travel control to control the vehicle 700 to automatically travel from the charger 400 to the exit gate 300 without the intervention of the driver of the vehicle 700 in the charging station S. The second automatic travel control allows the vehicle 700 to automatically travel from the charger 400 to the exit gate 300 along the travel path T2 illustrated in FIG. 1.

Since the travel path information includes the information on the coordinates of the locations located in the charging station S, the automatic travel controller 600b can execute the first automatic travel control and the second automatic travel control of the vehicle 700 in the charging station S.

As described above, in the embodiment of the disclosure, the first control device 500 generates the travel path information indicating the travel path T1 in the charging station S, based on the dimension information of the vehicle 700. The second control device 600 executes, based on the generated travel path information, the first automatic travel control to control the vehicle 700 to automatically travel to the charger 400 without the intervention of the driver of the vehicle 700 in the charging station S. The first automatic travel control based on the generated travel path information allows the vehicle 700 to automatically travel from the entrance gate 200 to the charger 400 without colliding with an obstacle in the charging station S.

The second control device 600 further executes, based on the travel path information indicating the travel path T2, the second automatic travel control to control the vehicle 700 to automatically travel from the charger 400 to the exit gate 300 without the intervention of the driver of the vehicle 700 in the charging station S. The second automatic travel control based on the generated travel path information allows the vehicle 700 to automatically travel from the charger 400 to the exit gate 300 without colliding with an obstacle in the charging station S.

Further, the generator 500c generates the travel path information, based on the positional relationship between the reference position of the vehicle 700 and the reference position in the charging station S. This allows the alignment of the reference position of the vehicle 700 and the reference position in the charging station S, and enables the vehicle 700 to automatically travel to an accurate position in the charging station S.

Further, the generator 500c generates the travel path information, based on the information related to the position of the charging port of the vehicle 700. The generator 500c can determine, based on the information related to the position of the charging port, whether the vehicle 700 is provided with the charging port on the right side or the left side thereof. Accordingly, the generator 500c can determine a more suitable one of the parking spaces provided on both sides of the charger 400 in accordance with the side of the vehicle 700 on which the charging port is disposed. As a result, the generator 500c can generate the travel path information to guide the vehicle 700 to the determined parking space.

Further, the generator 500c generates the travel path information such that the charging port of the vehicle 700 is located within the movable range of the charging gun of the charger 400 when the vehicle 700 stops in accordance with the first automatic travel control. This ensures that the cable of the charging gun reaches the charging port when the vehicle 700 comes to a stop in the parking space.

Further, the generator 500c generates the travel path information, based on the information related to the battery of the vehicle 700. This allows the vehicle 700 to be charged using the charger 400 supporting the type information of the battery mounted on the vehicle 700. Accordingly, the battery can be charged efficiently.

Further, the generator 500c generates the travel path information, based on the information related to the software used in the vehicle 700 for charging. This allows the vehicle 700 to be charged using the charger 400 supporting the version information of the software used for charging. Accordingly, the battery can be charged efficiently.

When the vehicle 700 moves to the exit gate 300, the first communicator 500a communicates with the second communicator 600a of the second control device 600, and notifies the driver of the vehicle 700 of the completion of the second automatic travel control in the charging station S. In response to the completion of the second automatic travel control, the driver of the vehicle 700 selects switching from the second automatic travel control to the third automatic travel control or switching to manual driving control with the intervention of the driver of the vehicle 700. If the switching to the manual driving control is selected, the driver manually drives the vehicle 700 outside the charging station S.

On the other hand, if the switching from the second automatic travel control to the third automatic travel control is selected, the automatic travel controller 600b executes the third automatic travel control, based on map data and information on the latitude and longitude of the location of the vehicle 700. The map data includes, for example, coordinate data of roads outside the charging station S. The information on the latitude and longitude of the location of the vehicle 700 is detected by, for example, the GNSS sensor mounted on the vehicle 700.

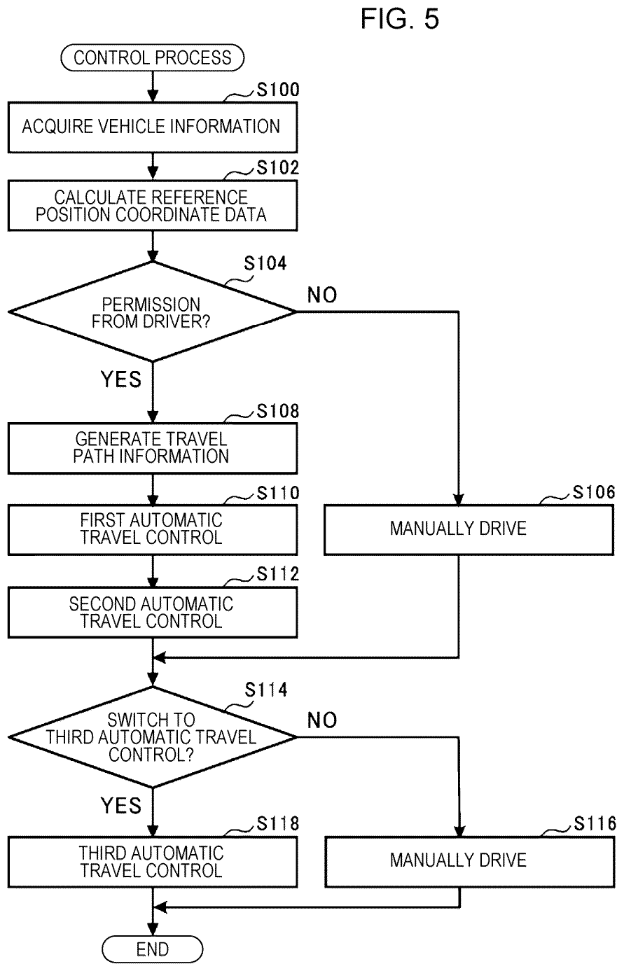

FIG. 5 is a flowchart of a control process performed in the control system 100 according to the embodiment of the disclosure. As illustrated in FIG. 5, first, the first communicator 500a communicates with the second control device 600 mounted in the vehicle 700 that comes to a stop at the entrance gate 200 to enter the charging station S, and acquires vehicle-related information of the vehicle 700 entering the charging station S (step S100). At this time, the first control device 500 controls the entrance gate 200 to change from the closed position to the open position to allow the vehicle 700 to enter the charging station S.

The determiner 500b calculates, based on the acquired vehicle-related information, the reference position coordinate data indicating the positional relationship between the reference position of the vehicle 700 and the reference position in the charging station S (step S102). The first communicator 500a requests permission from the driver of the vehicle 700 to execute the first automatic travel control and the second automatic travel control in the charging station S (step S104).

If the driver gives no permission to execute the first automatic travel control and the second automatic travel control (NO in step S104), the driver manually drives the vehicle 700 in the charging station S (step S106). On the other hand, if the driver gives permission to execute the first automatic travel control and the second automatic travel control (YES in step S104), the generator 500c generates travel path information indicating the travel paths T1 and T2 (step S108).

The generated travel path information is transmitted from the first communicator 500a to the second control device 600 via the second communicator 600a. The automatic travel controller 600b performs, based on the acquired travel path information, the first automatic travel control to control the vehicle 700 to automatically travel from the entrance gate 200 to any one of the chargers 400 (step S110). When the vehicle 700 arrives at the charger 400, the vehicle 700 automatically stops in a parking space for the charger 400. Thereafter, the charging port of the vehicle 700 and the charging gun of the charger 400 are automatically or manually coupled to each other, and the battery of the vehicle 700 starts to be charged.

When the charging of the battery of the vehicle 700 is completed, the automatic travel controller 600b performs, based on the travel path information, the second automatic travel control to control the vehicle 700 to automatically travel from the charger 400 to the exit gate 300 (step S112).

When the vehicle 700 arrives at the exit gate 300, the first communicator 500a communicates with the second communicator 600a of the second control device 600, and the first control device 500 controls the exit gate 300 to change from the closed position to the open position to allow the vehicle 700 to leave the charging station S. Further, the first communicator 500a notifies the driver of the vehicle 700 of the completion of the second automatic travel control in the charging station S. In response to the completion of the second automatic travel control, the driver selects switching from the second automatic travel control to the third automatic travel control or switching to the manual driving control with the intervention of the driver (step S114).

If the switching to the manual driving control is selected (NO in step S114), the driver manually drives the vehicle 700 outside the charging station S (step S116).

On the other hand, if the switching from the second automatic travel control to the third automatic travel control is selected (YES in step S114), the automatic travel controller 600b executes the third automatic travel control, based on the map data and the information on the latitude and longitude of the location of the vehicle 700 (step S118).

While a preferred embodiment of the disclosure has been described above with reference to the accompanying drawings, it is to be understood that the disclosure is not limited to such an embodiment. It will be apparent to those skilled in the art that various modifications and variations may be made without departing from the spirit or scope of the disclosure as defined in the appended claims.

A series of processes performed by devices, namely, the first control device 500 and the second control device 600 according to the embodiment of the disclosure described above, may be implemented using any of software, hardware, or a combination of software and hardware. A program implementing the software is stored in advance in, for example, a non-transitory storage medium (or non-transitory media) provided inside or outside the devices. For example, the program is read from a non-transitory storage medium (e.g., a ROM) to a transitory storage medium (e.g., a RAM) and executed by a processor such as a CPU.

It is possible to create a program for implementing each function of each of the devices described above and install the program in a computer of each of the devices described above. The processor executes the program stored in the memory, thereby executing the processing of each of the functions described above. At this time, the program may be shared and executed by multiple processors, or the program may be executed by a single processor. Each function of each of the devices described above may be implemented by cloud computing using multiple computers coupled to each other via a communication network.

The program may be provided and installed in the computer of each device by being distributed from an external device via a communication network. Alternatively, the program may be stored in a non-transitory computer-readable storage medium (or non-transitory computer readable medium) and provided and installed in the computer of each device via the storage medium.

According to the embodiment of the disclosure, it is possible to provide a program for executing the processing of each function of each of the devices described above. It is also possible to provide a non-transitory computer-readable storage medium in which the program is stored. The non-transitory storage medium may be, for example, a disk storage medium such as an optical disk, a magnetic disk, or a magneto-optical disk, or may be a semiconductor memory such as a flash memory or a Universal Serial Bus (USB) memory.

In the embodiment of the disclosure, in one example, both the first automatic travel control and the second automatic travel control are executed in the charging station S. However, at least the first automatic travel control executed in the charging station S can guide the vehicle 700 to any one of the chargers 400. Accordingly, the second automatic travel control in the charging station S is not required, and only the first automatic travel control may be executed in the charging station S. In other words, the generator 500c may generate only the travel path information of the travel path T1 without generating the travel path information of the travel path T2.

In the embodiment of the disclosure, furthermore, in one example, the travel path information is generated based on the positional relationship between the reference position of the vehicle 700 and the reference position in the charging station S. In another example, the travel path information is not generated based on the positional relationship.

In the embodiment of the disclosure, furthermore, in one example, the travel path information is generated based on the information related to the position of the charging port of the vehicle 700. In another example, the travel path information is not generated based on the information related to the position of the charging port.

In the embodiment of the disclosure, furthermore, in one example, the travel path information is generated such that the charging port of the vehicle 700 is located within the movable range of the charging gun of the charger 400 when the vehicle 700 stops in accordance with the first automatic travel control. In another example, the travel path information is not generated such that the charging port of the vehicle 700 is located within the movable range of the charging gun of the charger 400.

An embodiment of the disclosure provides automatic travel control in a charging station.

The first control device 500 illustrated in FIG. 3 and the second control device 600 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the first control device 500 including the first communicator 500a, the determiner 500b, and the generator 500c and to perform all or a part of functions of the second control device 600 including the second communicator 600a and the automatic travel controller 600b. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 3 and 4.

1. A control system comprising:
one or more processors; and
one or more memories coupled to the one or more processors,
the one or more processors being configured to execute processing comprising:
acquiring dimension information indicating a dimension of a vehicle entering a charging station;
generating travel path information indicating a travel path of the vehicle in the charging station, based on the dimension information and coordinate data of locations located in the charging station, the coordinate data of the locations located in the charging station being different from map data that is coordinate data of locations located outside the charging station; and
executing, based on the travel path information, first automatic travel control to control the vehicle to automatically travel to a charger in the charging station without intervention of a driver who drives the vehicle in the charging station.

2. The control system according to claim 1, wherein
the one or more processors are configured to execute processing comprising executing, based on the travel path information, second automatic travel control to control the vehicle to automatically travel from the charger to an exit of the charging station without the intervention of the driver in the charging station.

3. The control system according to claim 1, wherein
the one or more processors are configured to execute processing comprising generating the travel path information, based on a positional relationship between a reference position of the vehicle and a reference position in the charging station.

4. The control system according to claim 1, wherein
the one or more processors are configured to execute processing comprising generating the travel path information, based on information related to a position of a charging port of the vehicle.

5. The control system according to claim 2, wherein
the one or more processors are configured to execute processing comprising generating the travel path information, based on information related to a position of a charging port of the vehicle.

6. The control system according to claim 3, wherein
the one or more processors are configured to execute processing comprising generating the travel path information, based on information related to a position of a charging port of the vehicle.

7. The control system according to claim 4, wherein
the one or more processors are configured to execute processing comprising generating the travel path information such that the charging port of the vehicle is located within a movable range of a charging gun of the charger when the vehicle stops in accordance with the first automatic travel control.

8. The control system according to claim 5, wherein
the one or more processors are configured to execute processing comprising generating the travel path information such that the charging port of the vehicle is located within a movable range of a charging gun of the charger when the vehicle stops in accordance with the first automatic travel control.

9. The control system according to claim 6, wherein
the one or more processors are configured to execute processing comprising generating the travel path information such that the charging port of the vehicle is located within a movable range of a charging gun of the charger when the vehicle stops in accordance with the first automatic travel control.

10. The control system according to claim 1, wherein
the one or more processors are configured to execute processing comprising generating the travel path information, based on information related to a battery of the vehicle.

11. The control system according to claim 2, wherein
the one or more processors are configured to execute processing comprising generating the travel path information, based on information related to a battery of the vehicle.

12. The control system according to claim 3, wherein
the one or more processors are configured to execute processing comprising generating the travel path information, based on information related to a battery of the vehicle.

13. The control system according to claim 1, wherein
the one or more processors are configured to execute processing comprising generating the travel path information, based on information related to software used in the vehicle for charging.

14. The control system according to claim 2, wherein
the one or more processors are configured to execute processing comprising generating the travel path information, based on information related to software used in the vehicle for charging.

15. The control system according to claim 3, wherein
the one or more processors are configured to execute processing comprising generating the travel path information, based on information related to software used in the vehicle for charging.

16. A control device comprising:
one or more processors; and
one or more memories coupled to the one or more processors,
the one or more processors being configured to execute processing comprising:
executing first automatic travel control to control a vehicle entering a charging station to automatically travel to a charger in the charging station without intervention of a driver who drives the vehicle in the charging station, the first automatic travel control being executed based on travel path information indicating a travel path of the vehicle in the charging station, the travel path information being generated based on dimension information indicating a dimension of the vehicle and coordinate data of locations located in the charging station, the coordinate data of the locations located in the charging station being different from map data that is coordinate data of locations located outside the charging station.
